(19) United States
(12) Patent Application Publication
(10) Pub. No.: US 2014/0250759 A1
(43) Pub. Date: Sep. 11, 2014

(54) DIRECTIONAL RATTLE CALL

(71) Applicant: Theodore E. Franklin, Lancaster, OH (US)

(72) Inventor: Theodore E. Franklin, Lancaster, OH (US)

(21) Appl. No.: 13/784,976

(22) Filed: Mar. 5, 2013

(51) Int. Cl. A01M 31/00

(52) U.S. Cl. CPC A01M 31/004
USPC 43/1

(57) ABSTRACT

A directional rattle for imitating the sound of sparring dominate game animals. The directional rattle has a whorled portion on the rod that makes contact with concentric rings within the housing of the rattle. The manipulation of the rod within the housing results in a more authentic sound that resonates out of the bell shaped portion at the bottom that gives the sound a directional flow out and away from the device attracting game animals.

### BACKGROUND OF THE INVENTION

The use of devices to attract antlered animals by simulation of sparring antlered animals is not new to the art as there are many such devices available. Hunters rely on these simulated sounds to draw dominate male elk and deer into close proximity to capture these dominate animals during the mating season or as it is typically called rut.

One such device is U.S. Pat. No. 7,281,966 issued to McQueen on Oct. 16, 2007 entitled, “Antlered Animal Call”. The device comprises a striking rod and a box. The movement of the rod within the box is said to simulate the sound of antlers coming together or dominate males sparring.

It has been discovered that this device is limited in its sound generating abilities in that the sound is only generated from the nubs on the box. The present device has a better sound generation because both the rod and the housing have sound generation capabilities and a large open bottom. The rod has a whorled raised portion and the housing has a series of concentric rings forming a much smoother and consistent sound generation. The handle also has a more ergonomical shape allowing the device to be used easier than the prior art device.

The bottom of the present invention has a much larger opening allowing for greater directional sound resonation and authentic sound.

Another example of prior art is U.S. Pat. No. 8,096,849 issued to Knight on Jan. 17, 2012, entitled, “Rattle Stick for Attracting Animals”. This prior art device discloses a striking rod and a sleeve. The striking rod has knobs for sound generation when they come into contact with the sleeve. The sound generation is different from the present device, in that, the knobs only occur on the striking rod and not the sleeve, just the opposite of the McQueen device. It again suffers from some of the same weaknesses as McQueen. The fact that it lacks sound generation from both working parts makes it inferior to the present device. It also has no resonation chamber to give directional sound generation and a more authentic sound.

The present invention has a whorled raised portion on the striking rod and the housing has concentric rings that generate sound and then that sound resonates out of the open bottom generating a more authentic and louder sound that will travel directionally farther because it will resonate and travel out of the open bottom.

It has been discovered that the present invention with its dual sound generation capabilities and greater sound resonation because of the large open bottom produce a much more authentic directional sound that is louder, giving the present device advantages over any prior art.

### THE INVENTION

The present invention is a directional rattle for calling animals. The directional rattle comprises a hollow housing that has a top end, a bottom, an inside surface, a center axis and an opening through the center axis. The bottom of the bottom end is bell shaped.

The housing inside surface near the top is threaded. There is located in the opening a rod that has a top end, a bottom end and an outside surface. The rod has a raised whorled configuration on the outside surface essentially the entire length of the rod.

The rod has a cap comprised of a flat plate surmounting a threaded hub and a handle surmounting the flat plate. The threads on the threaded hub mate with the threads on the housing inside surface to attach the two components together for silent transportation.

The inside surface of the housing has a plurality of spaced-apart concentric rings. The rings are large enough to contact the raised whorled configuration when the rod is moved in the opening.

### BRIEF DESCRIPTION OF THE DRAWINGS

FIG. 1 is a full side view of the directional rattle.

FIG. 2 is a full top view of the directional rattle.

FIG. 3 is a cross sectional view of the directional rattle through line A-A of FIG. 2.

FIG. 4 is a view in perspective showing the housing of the directional rattle.

FIG. 5 is a full bottom view of the directional rattle.

FIG. 6 is a cross sectional view of the directional rattle through line B-B of FIG. 5.

FIG. 7 is a full view in perspective of the rod of the directional rattle.

### DETAILED DESCRIPTION OF THE DRAWINGS

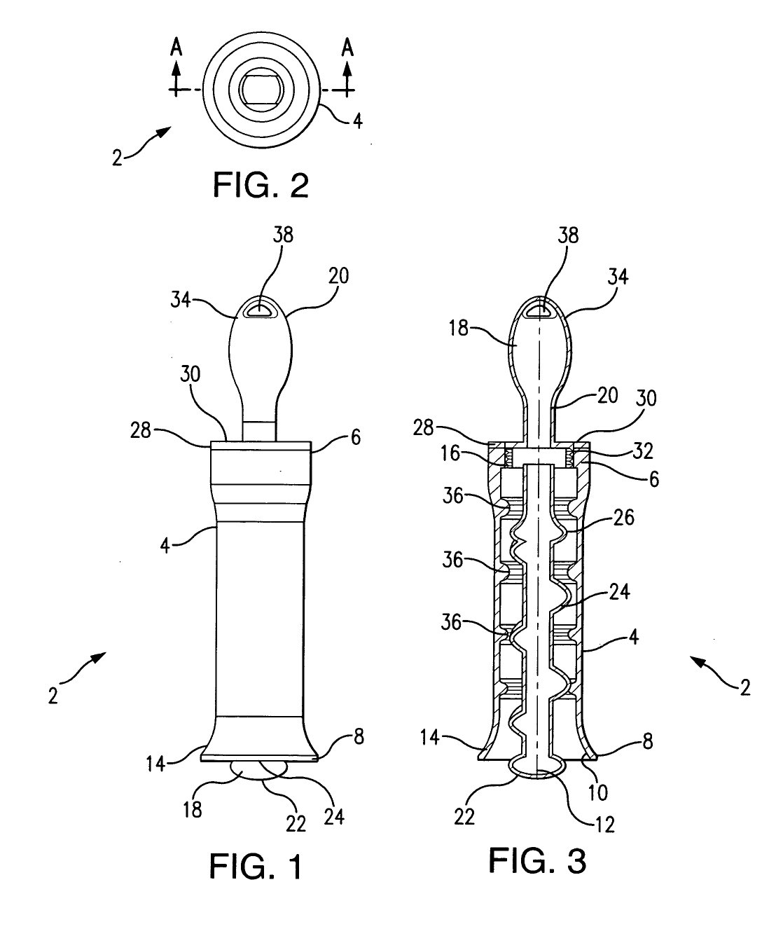

FIG. 1 shows the directional rattle 2 from the side. The housing 4 has a top end 6 and a bottom end 8. The housing 4 also has an inside surface 10. The bottom end 8 of the housing 4 has a bell shape 14. This bell shaped portion 14 is critical in that it has been discovered that the bell shaped 14 gives the directional rattle 2 better delivery of the sound as it is generated from the housing 4.

Also shown is the rod 18 which has a top 20 and a bottom 22. The outside surface 24 of the rod 18 is also shown. The rod 18 has a rod cap 28 that has a flat plate 30 and a threaded hub 32. The rod 18 also has a handle 34 that has an opening 38 at its top end 20. This opening 34 is available for a strap to secure the directional rattle 2 the user's wrist.

FIG. 2 shows line A-A through the housing 4 of the directional rattle 2.

FIG. 3 shows a cross section of the directional rattle 2 through line A-A. This cross sectional view allows for a view of the internal working components of the directional rattle 2. The rod 18 is threaded into the housing 4 giving it a secured position at the top end 6. The rod 18 is manipulated in an up and down fashion. The whorled portion 26 makes intermittent contact with the concentric rings 36 imitating the sparring sound or antler contact drawing the game animal into close proximity increasing the hunters chances of success.

The housing 4 has a top end 6 and a bottom end 8. It also has an inside surface 10, that has the concentric rings 36 on it. The rod 18 is secured along a centered axis 12 of the directional rattle 2. The top end 6 also has a threaded portion 16 where the rod 18 is secured into the housing 4.

The rod 18 has a top 20, a bottom 22 and an outside surface 24. The outside surface 24 has a whorled portion 26 that makes contact with the concentric rings 36 when the rod 18 is manipulated within the housing 4. The rod 18 has a cap 28 that features a flat plate 30 and a threaded hub 32 beneath the flat plate 30 that when placed in the threaded portion 16 of the housing 4, both components will thread together securing the rod 18 to the housing 4. The top 20 of the rod 18 has a handle portion 34 for manipulation of the rod 18 within the housing 4. Also shown in the top 20 of the rod 18 is an opening 38 that is capable of receiving a strap to secure the directional rattle 2 to the user or to carry the directional rattle 2.

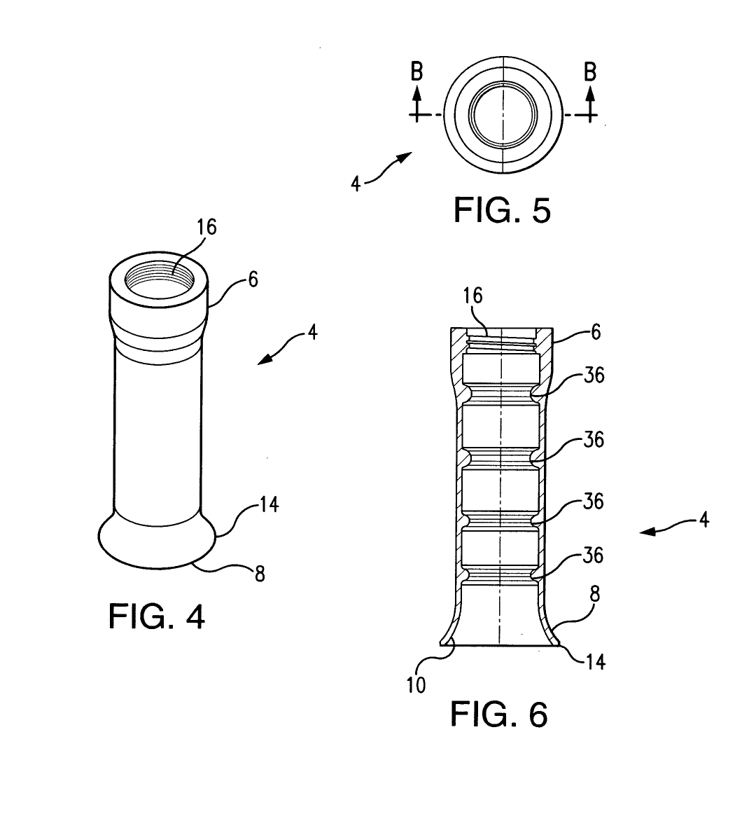

FIG. 4 shows the housing 4 of the directional rattle 2. The top end 6 shows the threaded portion 16 of the housing 4 for securing the rod 18. Also shown are the bottom 8 and the bell shape 14.

FIG. 5 shows line B-B through the housing 4 of the directional rattle 2.

FIG. 6 shows a cross section of the directional rattle 2 through line B-B. Again the threaded portion 16 of the housing 4 is clear at the top end 6. The bottom 8, the bell shaped portion 14 and the inside surface 10 are also very clear. This shows the relationship between the inside surface 10 and the series of concentric rings 36 that produce the sound when they come into contact with the whorled portion 26 of the rod 18.

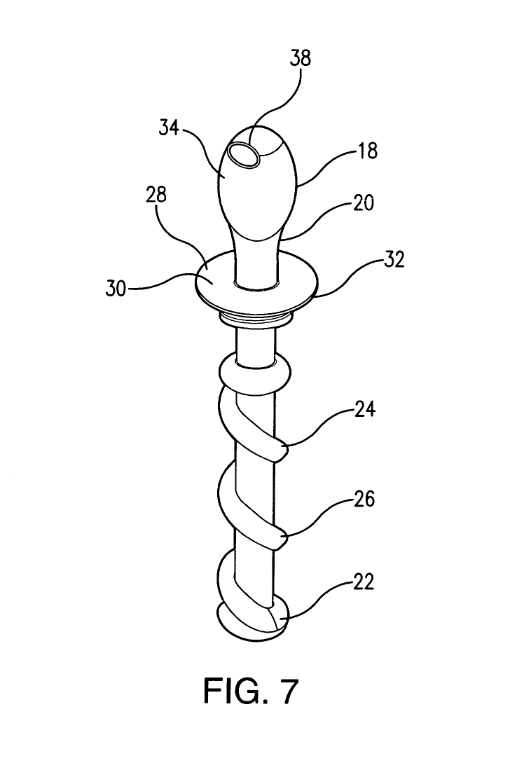

FIG. 7 shows the rod 18 of the directional rattle 2. It has been discovered that the rod 18 when manipulated creates a more authentic natural sound than other prior art device because of the whorled portion 26 making contact with the concentric rings 36.

The rod 18 has a top end 20, a bottom end 22 and an outside surface 24. Along the length of the rod 18 on its outside surface 24 is the whorled portion 26. The top 20 has a rod cap 28 that has a flat plate 30 and a threaded hub 32. Above the flat plate 30 is the handle 34 that contains an opening 38.

The user simply manipulates the rod 18 within the housing 4 to generate a sound that imitates the sound of dominate antlered animals sparring for territory and mates.

The multiple whorled raised portions and the multiple concentric rings emulate the multiple tines making contact simultaneously recreating a natural sound of dominated antlered animals fighting.

What is claimed is:

1. A directional rattle for calling animals, said directional rattle comprising:
a. a hollow housing having a top end, a bottom, an inside surface, a center axis and an opening through said center axis, wherein said bottom end is bell shaped;
b. said housing inside surface near said top being threaded;
c. located in said opening, a rod having a top end, a bottom end and an outside surface, said rod having a raised whorled configuration on said outside surface essentially the entire length of said rod;
d. said rod having a cap comprised of a flat plate surmounting a threaded hub and a handle surmounting said flat plate, said threads on said threaded hub mating with the threads on said housing inside surface;
e. said housing inside surface having a plurality of spaced-apart concentric rings, said rings being large enough to contact said raised whorled configuration when said rod is moved in said opening.
